(19) United States
(12) Patent Application Publication
(10) Pub. No.: US 2015/0044442 A1
(43) Pub. Date: Feb. 12, 2015

(54) FLEXIBLE SUBSTRATE AND METHOD FOR PREPARING THE SAME

(71) Applicant: EverDisplay Optronics (Shanghai) Limited, Shanghai (CN)

(72) Inventors: Tianwang Huang, Shanghai (CN); Chienlin Wu, Shanghai (CN)

(21) Appl. No.: 14/458,204

(22) Filed: Aug. 12, 2014

(30) Foreign Application Priority Data
Aug. 12, 2013 (CN) 201310349890.2

(51) Int. Cl. H04B 1/38; C03C 17/34; B05D 7/00

(52) U.S. Cl. CPC H04B 1/3888; B05D 7/54; C03C 17/34
USPC 428/216; 427/402; 427/407.1; 427/419.2; 428/426; 428/430; 428/441; 428/412; 428/419

(57) ABSTRACT

A method for manufacturing a flexible substrate comprises the steps of: providing a supporting plate; coating a first flexible layer on a side of the supporting plate; forming a barrier layer on the first flexible layer at its side opposite to the supporting plate, the barrier layer comprises multiple films stacked on top of one another; and coating a second flexible layer on the barrier layer at its side opposite to the first flexible layer, the barrier layer is coated by the first and second flexible layer.

### CROSS-REFERENCE TO RELATED APPLICATIONS

This application claims the benefits of Chinese Patent Application No. 201310349890.2, filed on Aug. 12, 2013 in the Patent Office of China, the disclosure of which is incorporated herein by reference in its entirety.

### TECHNICAL FIELD

The present disclosure relates in general to a flat panel display, in particular, to a flexible substrate and method for preparing the same, and a flat panel display together with its manufacturing method using the same.

### BACKGROUND ART

OLED (Organic Light Emitting Diode) display, characterized by self-luminous lighting, generally comprises a thinner coating layer of organic material, and glass substrate. The organic material may emit light when electricity flows through. The display screen of the OLED display has a wide vision and consumes substantially low electric power, such that the OLED display has remarkable superiority as compared with Liquid Crystal Display (LCD).

Although the OLED display has above advantageous, there are some considerable problems and restrictions to limit its applications in practice. One problem is that the organic materials and components in the OLED display may be affected when exposed to water vapor and/or oxygen. That is, the light emitting function of the organic electroluminescent material will be degraded when the organic material in the OLED display exposed to water vapor and/or oxygen. And some components in the OLED display such as active metallic cathode usually used in the OLED display will result in “dark spot areas” when the OLED display is exposed to these pollutants chronically, which may shorten the life of the OLED display. Consequently, it is beneficial to avoid an OLED display and thus the components and materials thereof being exposed to the polluted environment such as water vapour and oxygen.

In addition, the existing method for manufacturing the flexible OLED display is an adding up-peeling off method. In such method, a flexible substrate is added up to a hard supporting plate to produce a display component, and then peeled off from the hard supporting plate after the display component is finished. In particular, an organic plastic substrate is usually added up to a glass supporting plate through an adhesive; after the display component is finished, the back surface of the display component is scanned by a high-energy laser beam to age and degrade the adhesive, such that the organic plastic substrate could be stripped from the glass supporting plate. However, it is evidently disadvantageous in a lower producing efficiency and a worse peeling off uniformity due to the use of a high-energy laser beam in the process.

FIG. 1A illustrates a cross section view of an OLED display which is fabricated through a laser de-bonding process in prior art. The OLED display comprises a supporting plate 105, a silicon layer 106, a flexible layer 104, an OLED display unit, a packaging adhesive layer 101, and a cover 100. The silicon layer 106 is deposited on one side of the supporting plate 105 through a typical deposition process. The flexible layer 104 is formed on the silicon layer 106 at the side opposite to the supporting plate 105. The flexible layer 104 is made of organic polymer materials, such as polyisoprene. The OLED display unit comprises a TFT unit 103 formed on the flexible layer 104 at the side opposite to the supporting plate 105, and an OLED unit 102 formed on the TFT unit 103 at the side opposite to the flexible layer 104. The cover 100 is coated on its lower surface with the packaging adhesive layer 101, which is used for enveloping the OLED display unit, and is added up the flexible layer 104 at the side where the OLED display unit is formed. FIG. 1A further shows that the OLED display is scanned at its lower surface by a high-energy laser beam after being produced.

FIG. 1B illustrates a cross section view of an OLED display stripped by a laser beam in prior art. In particular, the OLED display comprises a supporting plate 105, a silicon layer 106, a flexible layer 104, an OLED display unit, a packaging adhesive layer 101, and a cover 100. When the OLED display is scanned at its lower surface by a laser beam, the silicon layer 106 expands and separate from the flexible layer 104, and the flexible layer 104 is thus stripped from the supporting plate 105. Thereafter, the OLED display comprising the flexible layer 104, the OLED display unit, the glue layer 101, and the cover 100, is obtained.

However, this process is deficient in lower producing efficiency, higher production cost and worse de-bonding uniformity due to the use of high-energy laser beam. Furthermore, it is not effective to prevent the OLED display together with the components and material therein being exposed to the environment such as water vapour and oxygen.

FIG. 2A illustrates a cross section view of an OLED display which is made by a mechanical de-bonding process in prior art. Particularly, the OLED display comprises a supporting plate 207, a binder layer 205, a releasing layer 206, a flexible layer 204, an OLED display unit, a packaging adhesive layer 201, and a cover 200. The releasing layer 206 is formed on the flexible layer 204 at the side opposite to the supporting plate 207. The binder layer 205 is positioned between the supporting plate 207 and the releasing layer 206. The area of the binder layer 205 is larger than that of the releasing layer 206. The bond strength between the binder layer 205 and the flexible layer 204 is larger than that between the releasing layer 206 and the flexible layer 204. The flexible layer 204 is made of organic polymer materials such as polyisoprene or polyethylene terephthalate (PET). The OLED display unit comprises a TFT unit 203 formed on the flexible layer 204 at the side opposite to the supporting plate 207, and an OLED unit 202 formed on the TFT unit 203 at the side opposite to the flexible layer 204. The packaging adhesive layer 201 for packing the OLED display unit is coated on the lower surface of the cover 200, and the cover 200 is added up to the flexible layer 204 at the side where the OLED display unit is formed.

FIG. 2B illustrates a cross section view of an OLED display which is stripped by a mechanical de-bonding process in prior art. Particularly, such an OLED display comprises a supporting plate 207, a binder layer 205, a releasing layer 206, a flexible layer 204, an OLED display unit, a packaging adhesive layer 201, and a cover 200. Since the bond strength difference between the binder layer 205 and the flexible layer 204 is different from that between the releasing layer 206 and the flexible layer 204, the flexible layer 204 can be peeled off from the supporting plate 207 by cutting away the exterior portion that does not contain the releasing layer 206 with lower bond strength after the OLED display is formed. Thereafter, an OLED display comprising the flexible layer 204, the OLED display unit, the glue layer 201 and the cover 200, is obtained.

However, the above method has disadvantages of worse de-bonding uniformity. Further, it is not effective to prevent the OLED display together with the components and material therein being exposed to the environment such as water vapor and oxygen.

The above information disclosed in this Background section is only for enhancement of understanding of the background of the disclosure and therefore it may contain information that does not form the prior art that is already known in this country to a person of ordinary skill in the art.

### SUMMARY OF INVENTION

The present disclosure provides quality detection devices for laser source and detection method thereof, in order to find abnormal initial laser light waves in advance and improve processing efficiency.

Additional aspects and advantages will be set forth in part in the description which follows and, in part, will be apparent from the description, or may be learned by practice of the disclosure.

According to one aspect of the disclosure, a method for manufacturing a flexible substrate is disclosed. The method comprises the steps of:

providing a supporting plate;

coating a first flexible layer on a side of the supporting plate;

forming a barrier layer on a side of the first flexible layer opposite to the side of the supporting plate, the barrier layer having multiple stacked films; and

coating a second flexible layer on the barrier layer at a side thereof opposite to the side of the first flexible layer, the barrier layer being surrounded by the first and second flexible layers.

According to one embodiment of the present disclosure, wherein the supporting plate is made of glass.

According to one embodiment of the present disclosure, wherein the first flexible layer is removable from the supporting plate.

According to one embodiment of the present disclosure, wherein both the first and the second flexible layers are made of same material.

According to one embodiment of the present disclosure, wherein the material is one selected from the group consisting of: polyethylene terephthalate, polyisoprene, polyethylene naphthalate, polyether sulfone, and polycarbonate.

According to one embodiment of the present disclosure, wherein the barrier layer comprises multiple stacked inorganic films.

According to one embodiment of the present disclosure, wherein each of the inorganic films is made of at least one material selected from the group consisting of: silicon nitride, silicon oxide, silicon oxynitride, and aluminum oxide.

According to one embodiment of the present disclosure, wherein the barrier layer comprises multiple stacked organic films.

According to one embodiment of the present disclosure, wherein each of the organic films is made of one material selected from the group consisting of: tetraethoxy silane, hexamethyl disiloxane, hexamethyl disilazane, octamethyl cyclotetrasiloxane, silicon oxycarbide, and silicon carbonitride.

According to one embodiment of the present disclosure, wherein the barrier layer comprises multiple organic and inorganic films alternately stacked on top of one another.

According to one embodiment of the present disclosure, wherein each of the inorganic film is made of at least one material selected from the group consisting of: silicon nitride, silicon oxide, silicon oxynitride, and aluminum oxide; and each of the organic film is made of one material selected from the group consisting of: tetraethoxy silane, hexamethyl disiloxane, hexamethyl disilazane, octamethyl cyclotetrasiloxane, silicon oxycarbide, and silicon carbonitride.

According to one embodiment of the present disclosure, wherein the first flexible layer has a thickness of 10-100 μm, and the second flexible layer has a thickness of 10-100 μm.

According to one embodiment of the present disclosure, wherein the barrier layer has a stress parameter of 5-200 MPa.

According to another aspect of the disclosure, A flexible substrate comprises a supporting plate; a first flexible layer coated on one side of the supporting plate; a barrier layer composed of multiple films and formed on the first flexible layer at its side opposite to the supporting plate; and a second flexible layer coated on the barrier layer at a side thereof opposite to the side of the first flexible layer and forming a structure together with the first flexible layer to surround the barrier layer.

According to one embodiment of the present disclosure, wherein the supporting plate is made of glass.

According to one embodiment of the present disclosure, wherein the flexible layer is removable from the supporting plate.

According to one embodiment of the present disclosure, wherein both the first and the second flexible layers are made of same material.

According to one embodiment of the present disclosure, wherein the material is one selected from the group consisting of: polyethylene terephthalate, polyisoprene, polyethylene naphthalate, polyether sulfone, and polycarbonate.

According to one embodiment of the present disclosure, wherein the barrier layer comprises multiple stacked inorganic films.

According to one embodiment of the present disclosure, wherein each of the inorganic films is made of at least one material selected from the group consisting of: silicon nitride, silicon oxide, silicon oxynitride, and aluminum oxide.

According to one embodiment of the present disclosure, wherein the barrier layer comprises multiple stacked organic films.

According to one embodiment of the present disclosure, wherein each of the organic film is made of one material selected from the group consisting of: tetraethoxy silane, hexamethyl disiloxane, hexamethyl disilazane, octamethyl cyclotetrasiloxane, silicon oxycarbide, and silicon carbonitride.

According to one embodiment of the present disclosure, wherein the barrier layer comprises multiple organic and inorganic films alternately stacked on top of one another.

According to one embodiment of the present disclosure, wherein each of the inorganic film is made of at least one material selected from the group consisting of: silicon nitride, silicon oxide, silicon oxynitride, and aluminum oxide; and each of the organic film is made of one material selected from the group consisting of: tetraethoxy silane, hexamethyl disiloxane, hexamethyl disilazane, octamethyl cyclotetrasiloxane, silicon oxycarbide, and silicon carbonitride.

According to one embodiment of the present disclosure, wherein the first flexible layer has a thickness of 10-100 μm, and the second flexible layer has a thickness of 10-100 μm.

According to one embodiment of the present disclosure, wherein the barrier layer has a stress parameter of 5-200 MPa.

In the present disclosure, since the flexible layer is coated with a barrier which is composed of multiple deposited and stacked films, it is realizable to prevent OLED display together with the components and material therein being exposed to polluted environment such as water vapor and oxygen. Additionally, as the flexible layer can be removed from the supporting plate simply by a mechanical force, the process for manufacturing OLED display is simplified, and the production cost is accordingly reduced.

### BRIEF DESCRIPTION OF THE DRAWINGS

The foregoing and other features and advantages of the disclosure will be apparent to those skilled in the art in view of the following detailed description, taken in conjunction with the accompanying drawings.

FIG. 1A illustrates a cross section view of an OLED display which is performed a laser de-bonding process in prior art.

FIG. 1B illustrates a cross section view of an OLED display which has been stripping through a laser beam in prior art.

FIG. 2A illustrates a cross section view of an OLED display which is performed a mechanical de-bonding process in prior art.

FIG. 2B illustrates a cross section view of an OLED display which has been stripped through a mechanical de-bonding process in prior art.

FIGS. 3A, 3B, 3C and 3D illustrate cross section views of a flexible substrate in changed states in the course of manufacturing according to the first embodiment of the present disclosure.

FIG. 4 illustrates a flow chart of a method for manufacturing a flexible substrate according to the first embodiment of the disclosure.

FIG. 5A illustrates a cross section view of a flat panel display according to the first embodiment of the disclosure.

FIG. 5B illustrates a cross section view of a flat panel display according to the second embodiment of the disclosure.

FIG. 6 illustrates a flow chart of a method for manufacturing a flexible substrate according to the second embodiment of the disclosure.

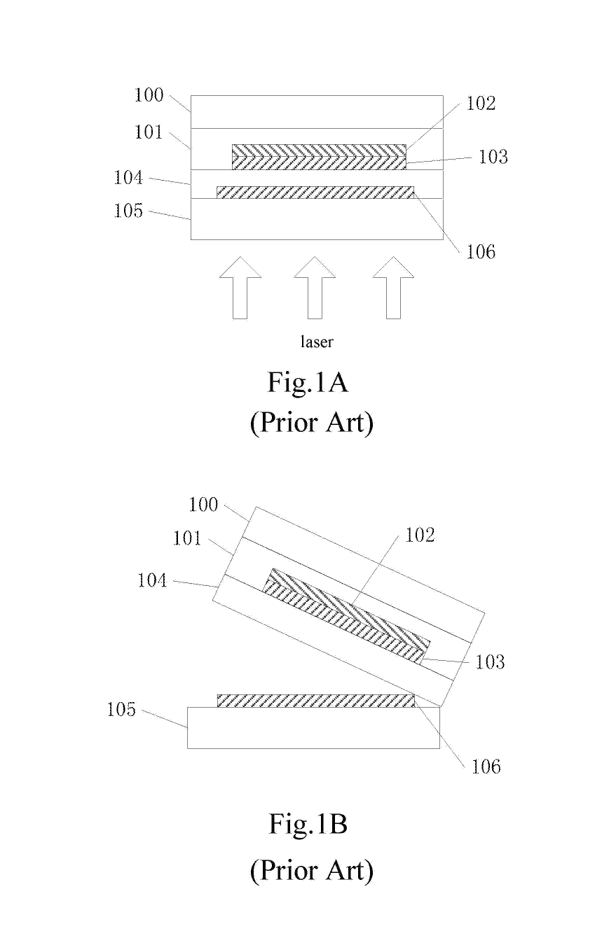

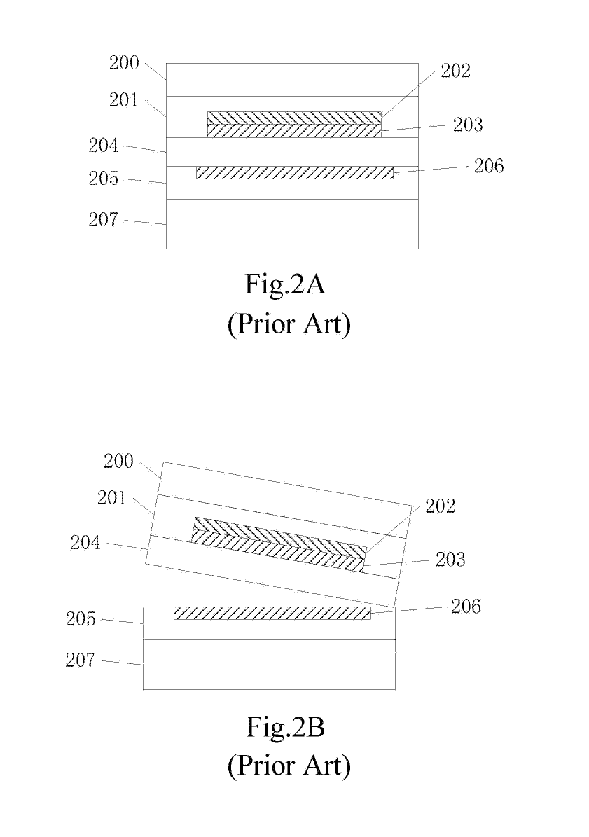

### DETAILED DESCRIPTION

Exemplary embodiments of the disclosure will now be described more fully with reference to the accompanying drawings, in which exemplary embodiments are shown. Exemplary embodiments of the disclosure may, however, be embodied in many different forms and should not be construed as being limited to the embodiments set forth herein; rather, these embodiments are provided so that this disclosure will be thorough and complete, and will fully convey the concept of exemplary embodiments to those skilled in the art. In the drawings, the thicknesses of layers and regions are exaggerated for clarity. Like reference numerals in the drawings denote like elements, and thus their description will be omitted.

The described features, structures, or/and characteristics of the disclosure may be combined in any suitable manner in one or more embodiments. In the following description, numerous specific details are disclosed to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

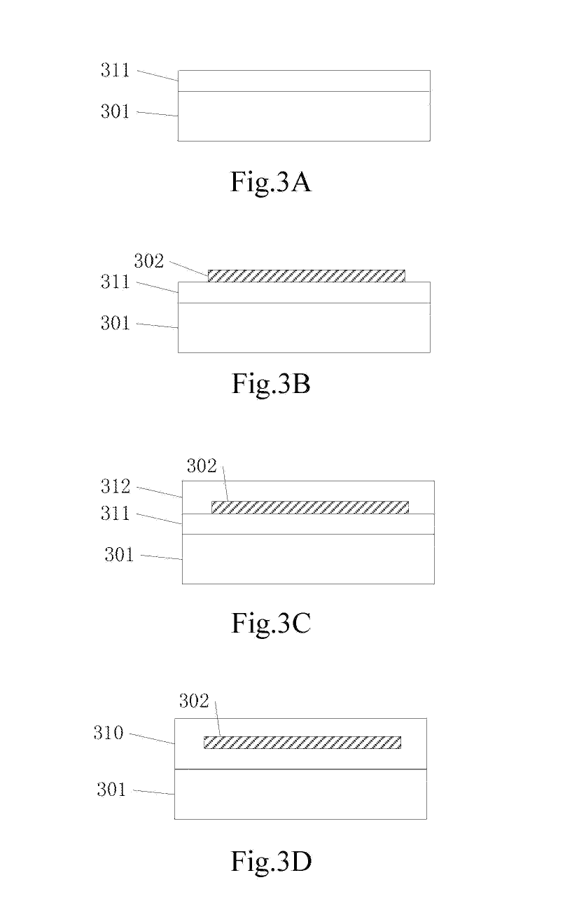

FIGS. 3A, 3B, 3C and 3D illustrate the varying cross section views of the flexible substrate during its manufacture according to the first embodiment of the present disclosure.

FIG. 3A shows a supporting plate 301 and a first flexible layer 311 coated on the upper surface of the supporting plate 301. The supporting plate 301 may be a glass supporting plate. The first flexible layer 311 may have a thickness of 10-100 μm, and be made of high-transmission and high-temperature-resistance material such as polyethylene terephthalate (PET), polyisoprene (PI), polyethylene naphthalate (PEN), polyether sulfone (PES), polycarbonate (PC) and so on.

FIG. 3B shows the supporting plate 301, the first flexible layer 311 coated on the upper surface of the supporting plate 301, and a barrier layer 302. The barrier layer 302 is formed on a side of the first flexible layer 311 opposite to the supporting plate 301, i.e. an upper surface of the first flexible layer 311 in FIG. 3B. As shown in FIG. 3B, the area of the barrier layer 302 is smaller than that of the first flexible layer 311. The barrier layer 302 is composed of multiple films stacked on top of one another, for example, multiple inorganic films. The inorganic film is made of one material selected from the group consisting of: silicon nitride, silicon oxide, silicon oxynitride, and aluminum oxide. In a modified embodiment, the barrier layer 302 is composed of multiple organic films stacked on top of one another. The organic film is made of one material selected from the group consisting of: organic silicon, such as tetraethoxy silane, hexamethyl disiloxane, hexamethyl disilazane, octamethyl cyclotetrasiloxane, silicon oxycarbide, and silicon carbonitride, etc. In another modified embodiment, the barrier layer 302 is composed of multiple organic and inorganic films alternately stacked stacked on top of one another. The inorganic film is made of one material selected from the group consisting of: silicon nitride, silicon oxide, silicon oxynitride, and aluminum oxide. The organic film is made of one material selected from the group consisting of: organic silicon, such as tetraethoxy silane, hexamethyl disiloxane, hexamethyl disilazane, octamethyl cyclotetrasiloxane, silicon oxycarbide, and silicon carbonitride, etc.

FIG. 3C shows the supporting plate 301, the first flexible layer 311 coated on an upper surface of the supporting plate 301, the barrier layer 302 and a second flexible layer 312. The barrier layer 302 is formed on a side of the first flexible layer 311 opposite to the supporting plate 301, i.e. an upper surface of the first flexible layer 311 in FIG. 3C. The second flexible layer 312 is formed on a side of the barrier layer 302 opposite to the first flexible layer 311, i.e. an upper surface of the barrier layer 302 in FIG. 3C. As shown in FIG. 3C, the area of the second flexible layer 312 is equal to that of the first flexible layer 311. The area of the barrier layer 302 is smaller than that of the first flexible layer 311. The barrier layer 302 is composed of multiple films stacked on top of one another, and the stress parameter thereof is 5-200 MPa. The second flexible layer 312 has a thickness of 10-100 μm, and is made of high-transmission and high-temperature-resistant material, such as polyethylene terephthalate (PET), polyisoprene (PI), polyethylene naphthalate (PEN), polyether sulfone (PES) or polycarbonate (PC).

FIG. 3D shows the supporting plate 301, a flexible layer 310 coated on the upper surface of the supporting plate 301 and the barrier layer 302 surrounded by the flexible layer 310. The flexible layer 310 is composed of the first flexible layer (referring to the reference number 311 in FIG. 3C) and the second flexible layer (referring to the reference number 312 in FIG. 3C) made of the same material with high transmission and high temperature resistance, such as polyethylene terephthalate (PET), polyisoprene (PI), polyethylene naphthalate (PEN), polyether sulfone (PES) or polycarbonate (PC). The flexible substrate in FIG. 3D is for example used in OLED display, in which the flexible layer 310 and the supporting plate 301 may be removed directly through mechanical force.

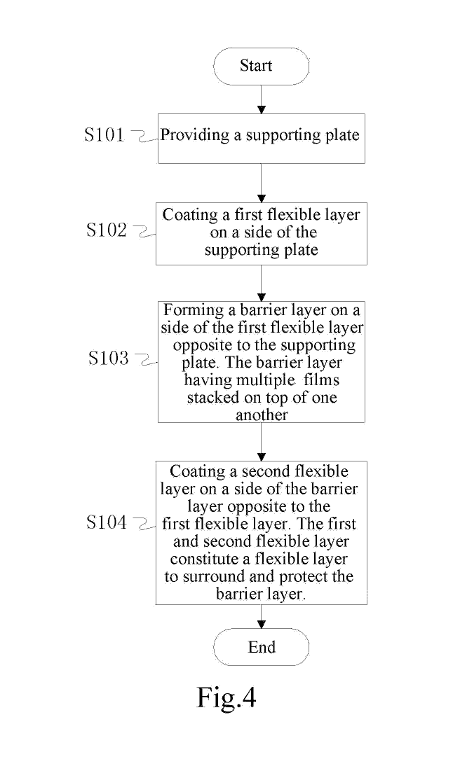

FIG. 4 illustrates a flow chart of a method for manufacturing a flexible substrate according to the first embodiment of the disclosure. 4 steps are shown in the FIG. 4.

Step S101: a supporting plate is provide, which may be a glass one.

Step S102: a first flexible layer is coated on a side of the supporting plate. The first flexible layer has a thickness of 10-100 μm, and is made of high-transmission and high-temperature-resistant material, such as polyethylene terephthalate (PET), polyisoprene (PI), polyethylene naphthalate (PEN), polyether sulfone (PES) or polycarbonate (PC).

Step S103: a barrier layer is formed on a side of the first flexible layer opposite to the supporting plate. The barrier layer is composed of multiple films stacked on top of one another, and the stress parameter thereof is 5-200 MPa. A contacting area between the barrier layer and the first flexible layer is smaller than that between the first flexible layer and the supporting plate.

Step S104: a second flexible layer is coated on a side of the barrier layer opposite to the first flexible layer. The first and second flexible layer constitute a flexible layer to surround and protect the barrier layer. The second flexible layer has a thickness of 10-100 μm, and is made of high-transmission and high-temperature-resistant material, such as polyethylene terephthalate (PET), polyisoprene (PI), polyethylene naphthalate (PEN), polyether sulfone (PES) or polycarbonate (PC).

The flexible substrate manufactured through the above Steps 101-104 is for example used in OLED display, in which the flexible layer and the supporting plate may be removed directly through mechanical force.

In another embodiment, the following 4 steps are performed:

Step S101A: a supporting plate is provide, which may a glass one.

Step S102A: a first flexible layer is coated on a side of the supporting plate. The first flexible layer has a thickness of 10-100 μm, and is made of high-transmission and high-temperature-resistant material, such as polyethylene terephthalate (PET), polyisoprene (PI), polyethylene naphthalate (PEN), polyether sulfone (PES) or polycarbonate (PC).

Step S103A: a barrier layer is formed on a side of the first flexible layer opposite to the supporting plate. The barrier layer is composed of multiple organic films stacked on top of one another. The organic film is made of one material selected from the group consisting of: organic silicon, such as tetraethoxy silane, hexamethyl disiloxane, hexamethyl disilazane, octamethyl cyclotetrasiloxane, silicon oxycarbide, and silicon carbonitride, etc. The stress parameter of the barrier layer is 5-200 MPa. A contacting area between the barrier layer and the first flexible layer is smaller than that between the first flexible layer and the supporting plate.

Step S104A: a second flexible layer is coated on a side of the barrier layer opposite to the first flexible layer. The first and second flexible layer constitute a flexible layer to surround and protect the barrier layer. The second flexible layer has a thickness of 10-100 μm, and is made of high-transmission and high-temperature-resistant material, such as polyethylene terephthalate (PET), polyisoprene (PI), polyethylene naphthalate (PEN), polyether sulfone (PES) or polycarbonate (PC).

The flexible substrate manufactured through the above Steps 101A-104A is for example used in OLED display, in which the flexible layer and the supporting plate may be removed directly through mechanical force.

In another embodiment, the following 4 steps are performed:

Step S101B: a supporting plate is provide, which may a glass one.

Step S102 B: a first flexible layer is coated on a side of the supporting plate. The first flexible layer has a thickness of 10-100 μm, and is made of high-transmission and high-temperature-resistant material, such as polyethylene terephthalate (PET), polyisoprene (PI), polyethylene naphthalate (PEN), polyether sulfone (PES) or polycarbonate (PC).

Step S103 B: a barrier layer is formed on a side of the first flexible layer opposite to the supporting plate. The barrier layer is composed of multiple inorganic films stacked on top of one another. The inorganic film is made of one material selected from the group consisting of: silicon nitride, silicon oxide, silicon oxynitride, and aluminum oxide. The stress parameter of the barrier layer is 5-200 MPa. A contacting area between the barrier layer and the first flexible layer is smaller than that between the first flexible layer and the supporting plate.

Step S104 B: a second flexible layer is coated on a side of the barrier layer opposite to the first flexible layer. The first and second flexible layer constitute a flexible layer to surround and protect the barrier layer. The second flexible layer has a thickness of 10-100 μm, and is made of high-transmission and high-temperature-resistant material, such as polyethylene terephthalate (PET), polyisoprene (PI), polyethylene naphthalate (PEN), polyether sulfone (PES) or polycarbonate (PC).

The flexible substrate manufactured through the above Steps 101B-104B is for example used in OLED display, in which the flexible layer and the supporting plate may be removed directly through mechanical force.

In another embodiment, the following 4 steps are performed:

Step S101C: a supporting plate is provided, which may a glass one.

Step S102C: a first flexible layer is coated on a side of the supporting plate. The first flexible layer has a thickness of 10-100 μm, and is made of high-transmission and high-temperature-resistant material, such as polyethylene terephthalate (PET), polyisoprene (PI), polyethylene naphthalate (PEN), polyether sulfone (PES) or polycarbonate (PC).

Step S103C: a barrier layer is formed on a side of the first flexible layer opposite to the supporting plate. The barrier layer is composed of multiple organic and inorganic films alternately stacked on top of one another. The inorganic film is made of one material selected from the group consisting of: silicon nitride, silicon oxide, silicon oxynitride, and aluminum oxide. The organic film is made of one material selected from the group consisting of: organic silicon, such as tetraethoxy silane, hexamethyl disiloxane, hexamethyl disilazane, octamethyl cyclotetrasiloxane, silicon oxycarbide, and silicon carbonitride, etc. The stress parameter of the barrier layer is 5-200 MPa. A contacting area between the barrier layer and the first flexible layer is smaller than that between the first flexible layer and the supporting plate.

Step S104C: a second flexible layer is coated on a side of the barrier layer opposite to the first flexible layer. The first and second flexible layer constitute a flexible layer to surround and protect the barrier layer. The second flexible layer has a thickness of 10-100 μm, and is made of high-transmission and high-temperature-resistant material, such as polyethylene terephthalate (PET), polyisoprene (PI), polyethylene naphthalate (PEN), polyether sulfone (PES) or polycarbonate (PC).

The flexible substrate manufactured through the above Steps 101C-104C is for example used in OLED display, in which the flexible layer and the supporting plate may be removed directly through mechanical force.

The combination of inorganic film with inorganic film, and the combination of inorganic film with organic film may be made of one selected from the group including the following material. For example, the combination of inorganic film with inorganic film may be the group of silicon nitride/silicon oxide, silicon nitride/silicon oxynitride, silicon nitride/silicon oxide/silicon nitride, silicon nitride/silicon oxynitride/silicon nitride, aluminum oxide/silicon oxynitride or aluminum oxide/silicon oxynitride/aluminum oxide. The combination of inorganic film and organic film may be the group of silicon nitride/tetraethoxy silane/silicon nitride, silicon nitride/hexamethyl disiloxane/silicon nitride, silicon nitride/hexamethyl disilazane/silicon nitride, silicon nitride/octamethyl cyclotetrasiloxane/silicon nitride, silicon nitride/silicon oxycarbide/silicon nitride, silicon nitride/silicon carbonitride/silicon nitride, aluminum oxide/tetraethoxy silane/aluminum oxide, aluminum oxide/hexamethyl disiloxane/aluminum oxide, aluminum oxide/hexamethyl disilazane/aluminum oxide, aluminum oxide/octamethyl cyclotetrasiloxane/aluminum oxide, aluminum oxide/silicon oxycarbide/aluminum oxide, and aluminum oxide/silicon carbonitride/aluminum oxide, etc.

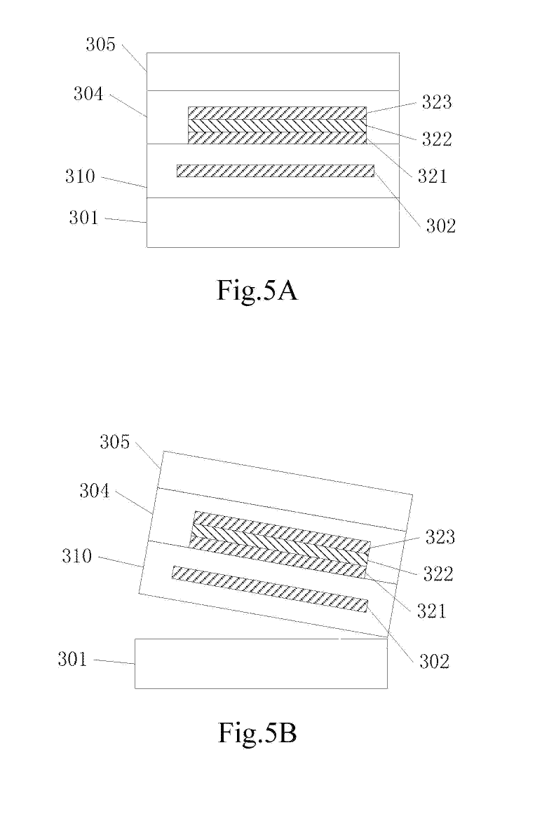

FIG. 5A illustrates a cross section view of a flat panel display according to the first embodiment of the disclosure. In particular, the flat panel display comprises a flexible substrate, a display unit, a glue layer 304 and a cover 305.

The flexible substrate comprises a supporting plate 301, a flexible layer 310 and a barrier layer 302. The supporting plate 301 may be a glass supporting plate.

The flexible layer 310 comprises a first flexible layer (referring to the reference number 311 in FIG. 3C) and a second flexible layer (referring to the reference number 312 in FIG. 3C) both of which have a thickness 10-100 μm. Both of the first and second flexible layer are made of high-transmission and high-temperature-resistant material, such as polyethylene terephthalate (PET), polyisoprene (PI), polyethylene naphthalate (PEN), polyether sulfone (PES) or polycarbonate (PC).

The barrier layer 302 is composed of multiple films stacked on top of one another, and the stress parameter thereof is 5-200 MPa. For example, the barrier layer 302 is composed of multiple inorganic films stacked on top of one another. The inorganic film is made of one material selected from the group consisting of: silicon nitride, silicon oxide, silicon oxynitride, and aluminum Oxide. In a modified embodiment, the barrier layer 302 is composed of multiple organic films stacked on top of one another. The organic film is made of one material selected from organic silicon, such as tetraethoxy silane, hexamethyl disiloxane, hexamethyl disilazane, octamethyl cyclotetrasiloxane, silicon oxycarbide, and silicon carbonitride, etc. In another modified embodiment, the barrier layer 302 is composed of multiple organic and inorganic films alternately stacked on top of one another. The inorganic film is made of one material selected from the group consisting of: silicon nitride, silicon oxide, silicon oxynitride, and aluminum oxide. The organic film is made of one material selected from organic silicon, such as tetraethoxy silane, hexamethyl disiloxane, hexamethyl disilazane, octamethyl cyclotetrasiloxane, silicon oxycarbide or silicon carbonitride, etc.

The display unit is an OLED display unit comprising a TFT unit 321, an OLED unit 322 and thin-film packing layer 323.

The first flexible layer is coated on an upper surface of the supporting plate 301. The barrier layer 302 is formed on a side of the first flexible layer opposite to the supporting plate 301. The second flexible layer 312 is coated on a side of the barrier layer 302 opposite to the first flexible layer. The barrier layer 302 is surrounded by the flexible layer 310 composed of the first and second flexible layer. As shown in FIG. 5A, the area of the barrier layer 302 is smaller than that of the flexible layer 310. The TFT unit 321 is formed on a side of the flexible layer 310 opposite to the supporting plate 301. The OLED unit 322 is formed on a side of the TFT unit 321 opposite to the flexible layer 310. The thin-film packing layer 323 is formed on a side of the OLED unit 322 opposite to the TFT unit 321. The glue layer 304, used for packaging the OLED display unit, is coated on the lower surface of the cover 305 being adhered to a side of the flexible substrate where the OLED display unit is formed.

FIG. 5B illustrates a cross section view of a flat panel display according to the second embodiment of the disclosure. In particular, the flat panel display comprises a flexible substrate, a display unit, a glue layer 304 and a cover 305. The flexible substrate comprises a supporting plate 301, a flexible layer 310 and a barrier layer 302. The flexible layer 310 comprises a first flexible layer (referring to the reference number 311 in FIG. 3C) and a second flexible layer (referring to the reference number 312 in FIG. 3C). The display unit is an OLED display unit comprising a TFT unit 321, an OLED unit 322 and thin-film packing layer 323.

The flexible layer 310 is stripped from the supporting plate 301 through mechanical force. For example, the flexible layer 310 is stripped from the supporting plate 301 by cutting process. After removing the flexible layer 310 from the supporting plate 301, the flexible substrate comprises the flexible layer 310 and the barrier layer 302. The flat panel display comprises the flexible layer 310, the barrier layer 302, the display unit, the glue layer 304 and the cover 305.

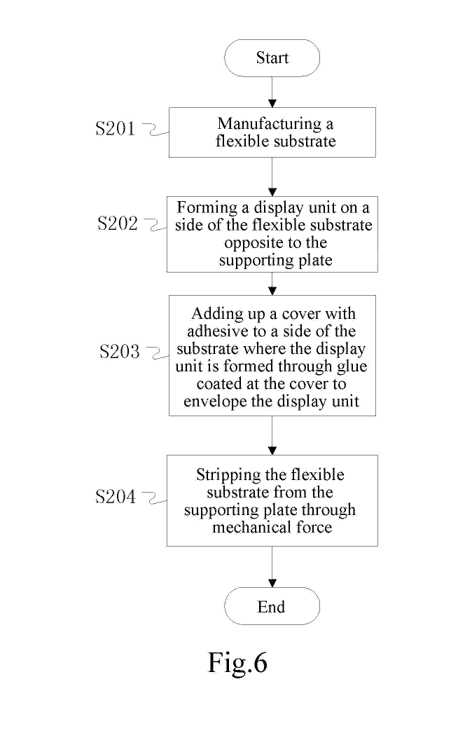

FIG. 6 illustrates a flow chart of a method for manufacturing a flexible substrate according to the second embodiment of the disclosure.

Step S201: a flexible substrate is provide, which may be formed in according to the Steps S101 to S104 as shown in FIG. 4. In particular, the flexible substrate comprises a supporting plate, a flexible layer and a barrier layer. The flexible layer comprises a first flexible layer and a second flexible layer. The display unit is an OLED display unit comprising a TFT unit, an OLED unit and thin-film packing layer.

Step S202: the display unit is formed on a side of the flexible substrate opposite to the supporting plate. For example, the flat panel display is an OLED display, and the display unit is an OLED display unit. The OLED display unit comprises a TFT unit, OLED unit and thin-film packing layer. The TFT unit is formed on a side of the flexible layer opposite to the supporting plate. The OLED display unit is formed on a side of the TFT unit opposite to the flexible layer. The thin-film packing layer is formed on a side of the OLED unit opposite to the TFT unit.

Step S203: a cover with adhesive is added up to the flexible substrate at the side where the display unit is formed so as to envelope the OLED display unit.

Step S204: the flexible substrate is stripped from the supporting plate through mechanical force. In particular, the flexible layer is stripped from the supporting plate by cutting process.

Exemplary embodiments have been specifically shown and described as above. It will be appreciated by those skilled in the art that the disclosure is not limited the disclosed embodiments; rather, all suitable modifications and equivalent which come within the spirit and scope of the appended claims are intended to fall within the scope of the disclosure.

What is claimed is:

1. A method for manufacturing a flexible substrate, comprising the steps of:
providing a supporting plate;
coating a first flexible layer on a side of the supporting plate;
forming a barrier layer on a side of the first flexible layer opposite to the side of the supporting plate, the barrier layer having multiple stacked films; and
coating a second flexible layer on the barrier layer at a side thereof opposite to the side of the first flexible layer, the barrier layer being surrounded by the first and second flexible layers.

2. The method of claim 1, wherein the supporting plate is made of glass.

3. The method of claim 1, wherein the first flexible layer is removable from the supporting plate.

4. The method of claim 3, wherein both the first and the second flexible layers are made of same material.

5. The method of claim 4, wherein the material is one selected from the group consisting of: polyethylene terephthalate, polyisoprene, polyethylene naphthalate, polyether sulfone, and polycarbonate.

6. The method of claim 1, wherein the barrier layer comprises multiple stacked inorganic films.

7. The method of claim 6, wherein each of the inorganic films is made of at least one material selected from the group consisting of: silicon nitride, silicon oxide, silicon oxynitride, and aluminum oxide.

8. The method of claim 1, wherein the barrier layer comprises multiple stacked organic films.

9. The method of claim 8, wherein each of the organic films is made of one material selected from the group consisting of: tetraethoxy silane, hexamethyl disiloxane, hexamethyl disilazane, octamethyl cyclotetrasiloxane, silicon oxycarbide, and silicon carbonitride.

10. The method of claim 1, wherein the barrier layer comprises multiple organic and inorganic films alternately stacked on top of one another.

11. The method of claim 10, wherein each of the inorganic film is made of at least one material selected from the group consisting of: silicon nitride, silicon oxide, silicon oxynitride, and aluminum oxide; and each of the organic film is made of one material selected from the group consisting of: tetraethoxy silane, hexamethyl disiloxane, hexamethyl disilazane, octamethyl cyclotetrasiloxane, silicon oxycarbide, and silicon carbonitride.

12. The method according to claim 1, wherein the first flexible layer has a thickness of 10-100 μm, and the second flexible layer has a thickness of 10-100 μm.

13. The method according to claim 1, wherein the barrier layer has a stress parameter of 5-200 MPa.

14. A flexible substrate, comprising:
a supporting plate;
a first flexible layer coated on one side of the supporting plate;
a barrier layer composed of multiple films and formed on the first flexible layer at its side opposite to the supporting plate; and
a second flexible layer coated on the barrier layer at a side thereof opposite to the side of the first flexible layer and forming a structure together with the first flexible layer to surround the barrier layer.

15. The flexible substrate of claim 14, wherein the supporting plate is made of glass.

16. The flexible substrate of claim 14, wherein the flexible layer is removable from the supporting plate.

17. The flexible substrate of claim 16, wherein both the first and the second flexible layers are made of same material.

18. The flexible substrate of claim 17, wherein the material is one selected from the group consisting of: polyethylene terephthalate, polyisoprene, polyethylene naphthalate, polyether sulfone, and polycarbonate.

19. The flexible substrate of claim 14, wherein the barrier layer comprises multiple stacked inorganic films.

20. The flexible substrate of claim 19, wherein each of the inorganic films is made of at least one material selected from the group consisting of: silicon nitride, silicon oxide, silicon oxynitride, and aluminum oxide.

21. The flexible substrate of claim 14, wherein the barrier layer comprises multiple stacked organic films.

22. The flexible substrate of claim 21, wherein each of the organic film is made of one material selected from the group consisting of: tetraethoxy silane, hexamethyl disiloxane, hexamethyl disilazane, octamethyl cyclotetrasiloxane, silicon oxycarbide, and silicon carbonitride.

23. The flexible substrate of claim 14, wherein the barrier layer comprises multiple organic and inorganic films alternately stacked on top of one another.

24. The flexible substrate of claim 23, wherein each of the inorganic film is made of at least one material selected from the group consisting of: silicon nitride, silicon oxide, silicon oxynitride, and aluminum oxide; and each of the organic film is made of one material selected from the group consisting of: tetraethoxy silane, hexamethyl disiloxane, hexamethyl disilazane, octamethyl cyclotetrasiloxane, silicon oxycarbide, and silicon carbonitride.

25. The flexible substrate of claim 14, wherein the first flexible layer has a thickness of 10-100 μm, and the second flexible layer has a thickness of 10-100 μm.

26. The flexible substrate of claim 14, wherein the barrier layer has a stress parameter of 5-200 MPa.
